(19) United States
(12) Patent Application Publication
(10) Pub. No.: US 2010/0186527 A1
(43) Pub. Date: Jul. 29, 2010

(54) CENTRIFUGAL SYSTEM

(76) Inventors: Guy Silver, Cupertino, CA (US); Juinerong Wu, Reno, NV (US)

Correspondence Address: Haynes and Boone, LLP;IP Section, 2323 Victory Avenue, SUITE 700, Dallas, TX, 75219, US

(21) Appl. No.: 12/359,132

(22) Filed: Jan. 23, 2009

(51) Int. Cl. F16H 33/02; F16H 33/20

(52) U.S. Cl. 74/64; 74/84 R

(57) ABSTRACT

A centrifugal system transmits a centrifugal force from a favorably positioned rotational object with a mass element to an arm that is coupled to an output axle or directly to the axle or a structure on the system, so as to provide output torque or force. The centrifugal system uses rotational motion of one or more mass elements in an object to create a centrifugal force that drives the mass elements radially outward, so that the centrifugal force creates a tangential force which acts at an angle on an arm to provide a significant amount of torque to rotate an output axle of the system. The centrifugal force of the system may also be used to create force output for the system. The angle is the angle between a connection element and the arm or axis of rotation. The angle determines the magnitude of the effective force for torque or force creation. The objects—particularly, their mass elements—of the centrifugal system are designed to drive the arms of the torque system mechanically or create a force on the force system. Objects may have adjustable connection elements or connection element configurations, such that the objects impart energy for the arms to rotate centrifugal system. The torque achieved in a torque system or the force achieved in a force system can be controlled by adjusting the amount of centrifugal forces created by the objects. The centrifugal system may be in open space or enclosed. Various considerations of system configuration, object configuration, object mass, connection locations, location of mass to the axis of rotation, torque arm length, and angle of centrifugal force are design parameters that can be tuned to achieve high performance. The torque created can be used to drive rotary motion of an output axle, for example. The force created can be used to drive linear motion on an output axle or the system, for example.

### BACKGROUND OF THE INVENTION

1. Field of the Invention

The present invention relates to systems and methods for creating torque or force using a rotary system. In particular, the present invention relates to systems and methods that utilize centrifugal forces for moving objects, applying the centrifugal forces at useful locations so as to create torque or a directional force. Such systems include one that transforms rotational motion of one or more objects into mechanical energy or a force, taking advantage of the object configuration in the system.

2. Discussion of the Related Art

In a rotating reference frame, the centrifugal force, which is a pseudo-force associated with rotation, points radially outward from the axis of rotation. A particle that revolves with uniform speed v in a circle of radius r undergoes a centripetal acceleration a_{c}, which is given by:

$${a}_{c} = \frac{{υ}^{2}}{r} .$$

An object moving uniformly in a circle, such as a ball held at the end of the string experiences a centripetal force. The magnitude of the centripetal force is provided by Newton's Second Law, F=ma. According to Newton's Third Law, the centrifugal force is equal and opposite to the centripetal force. Thus, the magnitude of centrifugal force is equal to the centripetal force. The magnitude of the centrifugal force F is therefore provided by:

$$F = {ma}_{c} = m \frac{{υ}^{2}}{r} .$$

The angular velocity is given by V=rω. Therefore, the magnitude of the centrifugal force F can also be written as:

F=m r ω²;

Consider a mass M tied by a string of length R and set in rotational motion around a center of rotation at an angular velocity of ω. The mass rotates in a circular path because of the centripetal force F=M R ω² pulling on the mass by the string. The reaction force exerted by the rotating mass M, is equal and opposite in direction to the centripetal force. Therefore, the centrifugal force is also M R ω², in a radial direction away from the center of rotation.

### SUMMARY

The present invention provides a centrifugal system may be configured to a torque system or a force system, which transmits a centrifugal force from a favorably positioned rotational object with a mass element to an arm or to the system that is coupled to an output axle, so as to provide output torque or force. In one embodiment, a torque system uses rotational motion of one or more mass elements in an object to create a centrifugal force that drives the mass elements radially outward, so that the centrifugal force acts at an angle on an arm, thus providing a significant amount of torque to rotate an output axle of the torque system. The angle between a connection element and the arm determines the magnitude of the effective force for torque creation. In one embodiment, a force system uses the rotational motion of one or more mass elements of an object to create a centrifugal force that drives the mass elements radially outward, and the centrifugal force is redirected to provide a significant force which moves an external structure or the force system in linear motion (forward or backward).

The objects—particularly, their mass elements—of a torque system are designed to drive the arms of the torque system mechanically. The objects—particularly, their mass elements—of a force system are designed to drive the force system in linear motion. In one embodiment, objects may have adjustable connection elements or connection element configurations, such that the objects impart energy to the arms to rotate the torque system or to provide a force that pushes or pulls the force system or an external system in linear motion. The torque achieved in a torque system can be controlled by adjusting the amount of centrifugal forces created by the objects. The force achieved in a force system can be controlled by adjusting the amount of centrifugal forces created by the objects.

The torque system or the force system may operate in open space or be enclosed. Various considerations of system configuration, object configuration, object mass, connection locations, location of mass to the axis of rotation, torque arm length, and angle of centrifugal force are design parameters that can be tuned to achieve high performance. The torque created by the torque system can be used to drive rotary motion of an output axle, for example. The force created by the force system can be used to drive linear motion of an external structure or the force system itself.

The present invention is better understood upon consideration of the detailed description below, in conjunction with the accompanying drawings.

### BRIEF DESCRIPTION OF THE DRAWINGS

FIG. 1 shows, schematically, torque system 100 in a non-operating configuration, in accordance with one embodiment of the present invention.

FIG. 2 shows, schematically, torque system 200 which is enclosed in a housing, in accordance with one embodiment of the present invention.

FIG. 3 shows, schematically, torque system 300, in accordance with an embodiment of the present invention.

FIG. 4 shows, schematically, torque system 400 having compressed springs, in accordance with an embodiment of the present invention.

FIG. 5 shows a perspective view of torque system 500, in accordance with an embodiment of the present invention.

FIG. 6 shows a perspective view of torque system 600, in accordance with an embodiment of the present invention.

FIG. 7 shows a perspective view of force system 700, according to an embodiment of the present invention.

FIG. 8 shows a perspective view of force system 800, according to an embodiment of the present invention.

FIGS. 9a to 9e show top views of objects 900, 910, 920, 930, 940, 950, 960 and 970 which are coupled to axle 901 and arm 902 to form torque systems 900, 910, 920, 930, 940, 950, 960 and 970, respectively, according to one embodiment of the present invention.

FIG. 10 shows a perspective view of torque system 1000, according to one embodiment of the present invention.

To facilitate cross-referencing among the figures, like elements are assigned like reference numerals.

### DETAILED DESCRIPTION OF THE PREFERRED EMBODIMENTS

This present application relates to a centrifugal system that may be configured into a torque system or a force system. The centrifugal system uses centrifugal forces created by the rotational motions of one or more objects to create torque for driving a drive shaft (for example, axle) or to create force. Thus, the torque system directs a centrifugal force to create rotational motion for providing mechanical energy, and the force system redirects a centrifugal force into a linear directional force. In one embodiment, to create torque, a torque system of the present invention utilizes a centrifugal force of a rotating object that acts on an arm. The centrifugal force is applied on the torque's arm about an axis of rotation of the arm, where an axle is affixed, so that the centrifugal force creates a torque that sets the arm into rotational motion. The magnitude of the torque or force created by the rotating object of a centrifugal system is proportional to the mass of the object, the length of the torque's arm and the square of the angular velocity of the rotation. According to the present invention, the torque system or the force system may be enclosed in a space filled with a fluid or vacuum (i.e., an evacuated space).

A centrifugal system can have multiple objects in many different configurations coupled to drive the motion of the axle located at a common axis of rotation. In a torque system, when the objects rotate, the centrifugal force of each object induces a torque which keeps the centrifugal system rotating, thus providing rotational mechanical energy for the torque system. In a force system, the centrifugal force of each object induces a force which is directed to provide a linear output force. In one embodiment, a basic object structure of the centrifugal system includes a mass element and a connection element. The mass element may consist of one or more masses. A connection element, which may be rigid for a torque system and non-rigid for a force system, and may consist of multiple sections, couples the mass element to an axle or the arm or a structure of the system. The connection element may consist of, for example, a rod, a spring or a bar. The axle of the torque system may be used to drive external machinery or a generator. The output of the force system may be used to drive an external system to linear motion.

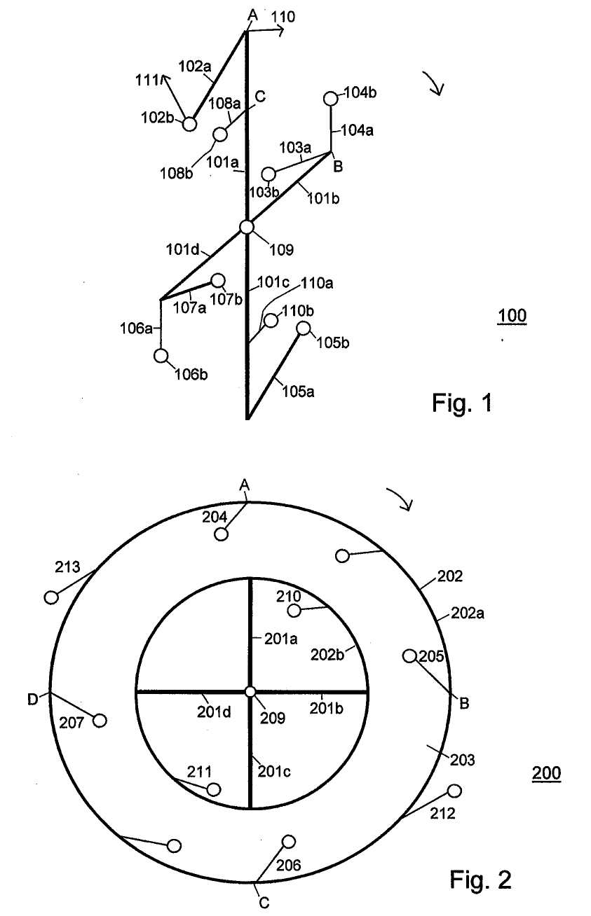

FIG. 1 shows torque system 100 to be an open system having eight objects (labeled in FIG. 1 as 102, 103, 104, 105, 106, 107, 108 and 110) structurally attached to axle 109 through arms 101a, 101b, 101c and 101d, respectively. Objects 102, 103, 104, 105, 106, 107, 108 and 110 are structurally supported by support arms 101a, 101b, 101c and 101d, which are coupled to axle 109. Axle 109 may be used to output the torque generated by the objects. Each support arm may be provided with blades (i.e., air-foil shape sections) for creating lift forces. In FIG. 1, an object consists of a mass element (i.e., any of the mass elements labeled 102b, 103b, 104b, 105b, 106b, 107b, 108b and 110b) which is attached to a connection element (i.e., any of the connection elements labeled 102a, 103a, 104a, 105a, 106a, 107a, 108a and 110a) at a connection location (e.g., in FIG. 1, the points labeled A and B, or any location along arms 101a, 101b, 101c and 101d) to create a torque to power the system. Each connection location where torque is generated may have one or more objects connected. An example of a connection location having one object is connection location A at a predetermined radial distance from the axis of rotation, showing object 102 being connected by connection element 102a. An example of a connection location having two objects connected is connection location B, where objects 102 and 103 are connected to connection location B by connection elements 102a and 103a respectively. Also, each arm may have multiple connection locations. For example, arm 101a has connection locations A and C.

A connection element may consist of multiple sections and may include bends or curves that are provided to position the mass element relative to the connection location as desired. The design of the connection element also affects the angle at which the connection element connects to the connection location, which may increase the torque created by the object. The mass element may be positioned on the same or different plane formed by the connection location and the axle. In FIG. 1, connection elements 101a, 101b, 101c and 101d for torque system 100 are illustrated as single straight rods positioned on the same plane as the connection location. Torque system 100 is a balanced system. The connection elements and the arms may be formed by any material that can withstand the forces acting on them, as described below, including metal, plastic or composites. During operation, objects 102, 103, 104, 105, 106, 107, 108 and 110 provide sufficient torque to compensate any loss due to friction. The output torque at axle 109 is the sum of the individual torques generated by objects 102, 103, 104, 105, 106, 107, 108 and 110. The efficiency of torque system 100 may be increased by orienting the objects such that the centrifugal forces act on each arm in a preferred angle, so as to maximize the torque created.

Once torque system 100 is set into rotational motion initially by a rotational motion of axle 109, a centrifugal force is created on each object. Assuming the mass element of each object is significantly larger than its associated connection element, the direction of the centrifugal force acting on the object is approximately along a radial direction pointing from axle 109 to the center of mass of the mass element. A portion of the centrifugal force created on each object is directed tangentially at the connection location, based on the direction of the centrifugal force and the connection angle of the connection element to the arm. For example, centrifugal force 111 provides tangential force 110 at connection location A. Since object 102 maintains the same position relative to arm 101a as torque system 100 rotates, tangential force 111 created by centrifugal force 110 is independent of the rotational position of arm 101 relative to the axle 109. The torque created at each connection location is the tangential force times the radial distance between the connection location and axle 109. The total torque created by torque system 100 is sum of the torques created at all connection locations.

The torque in the rotary motion of the axle 109 may be used to drive external machinery. In torque system 100, using gearing or other configurations, axle 109 may be made to rotate at a different velocity than of the velocity of any arm or object (i.e., different than the velocity of any of arm 101a and 101b, and objects 102, 103, 104 and 108).

In one embodiment, an object (e.g., 102, 103, 104, 105, 106, 107, 108 and 110) may be locate anywhere within the torque system to create a desirable torque. More than one object or set of objects may be provided to drive the torque system to do work.

Torque system 100 may be enclosed in a housing filled with fluid or air, or enclosing a vacuum environment. The centrifugal force from the mass elements of the rotating objects are transmitted to the arms which couple axle 109 inside torque system 100. The arms, in turn, create torques in axle 109, which may be used to further create torque. In the absence of friction or air resistance (e.g., in a vacuum or evacuated environment), the mass elements will continue its rotational motion. Centrifugal force is maintained only for so long as the masse elements in the objects rotate.

FIG. 2 shows torque system 200 having enclosed housing 202, which includes wall portions 202a and 202b that are connected to axle 209 by arms 201a, 201b, 201c and 201d, respectively. Torque system 200 includes a hollow inside space (i.e., housing space 203) which provides room for placement of objects. Objects 204, 205, 206 and 207 which are located within housing space 203 are structurally attached to the interior walls of wall portion 202a. To drive axle 209, each object is oriented to maximize the torque due to rotational motion during operation. In FIG. 2, objects 210 and 211 are shown located outside housing 202 and are positioned along an exterior wall of wall portion 202b, and each object is oriented to maximize torque creation. Objects 212 and 213 are shown located outside housing 202 and are positioned along an exterior wall of wall portion 202a, with each object being oriented to maximize torque creation. The objects may be connected to the interior walls (e.g., within housing space 203) or the exterior walls of wall portion 202b and wall portion 202a.

Arms 201a, 201b, 201c and 201d may extend into housing space 203. Once torque system 200 is set into rotational motion initially, the centrifugal forces due to the objects create tangential forces at the connection locations, as described above. Torque system 200 provides an example in which the housing rotates in a predetermined direction. Rotary motion of torque system 200 may be used to drive machinery through an axle or a gear system coupled externally to the housing 202. Having the housing rotate allows the housing to act as a flywheel which stores the mechanical energy created in torque system 200. Housing space 203 may be filled with a fluid to modify the mass of housing 202, so as to adjust the energy storage capability of the flywheel.

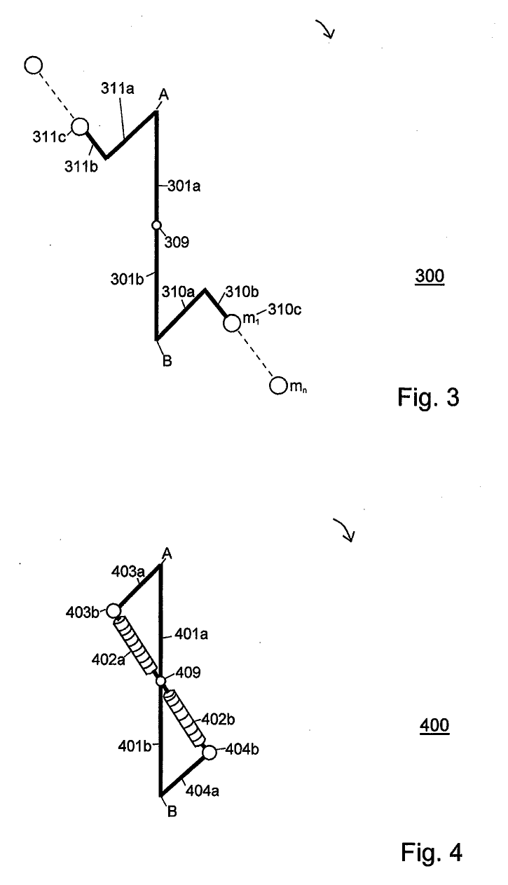

As discussed above, a connection element may have multiple sections. FIG. 3 shows torque system 300 having objects 310 and 311 that are connected to arms 301a and 301b. Arms 301a and 301b are, in turn, connected to axle 309. Objects 310 and 311 each include a connection element having two sections, one section being connected to the arm (i.e., section 310a or section 311a), while the other section being extended in the same direction as the centrifugal force (i.e., section 310b or section 311b). Having a section extending outward in the same direction as the centrifugal force provides an increase in centrifugal force created by an object while keeping the same connection angle to the arm.

Torque systems 100, 200 and 300 are set into rotational motion initially by external power, which provides the centrifugal forces in the systems. A torque system may be made self-starting when provided a tension device (e.g., a compressed spring). Such a tension device may be used to create a force acting on one or more objects within the system. FIG. 4 shows torque system 400 having compressed springs 402a and 402b which create forces acting on mass elements 403b and 404b of object objects 403 and 404, respectively. The forces created by springs 402a and 402b are in the same direction as the centrifugal force created by the objects, creating a tangential force at connection locations A and B. The sum of the tangential forces may be used to start the rotation and to increase the total torque of torque system 400.

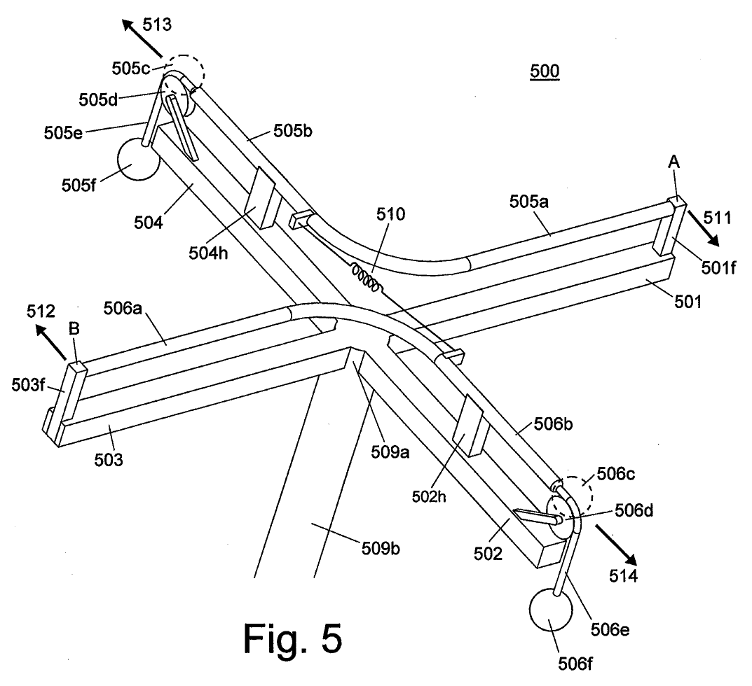

FIG. 5 shows torque system 500 which includes objects 505 and 506 connected to arms 501 and 503 by raised elements 501f and 503f, respectively. The junction of object 505 with raised element 501f represents connection location A. Similarly, the junction of object 506 with raised element 503f represents connection location B. Optional supports may be provided for objects 505 and 506, in consideration of the lengths of their respective connection elements. For example, support arms 502 and 504, having raised elements 502h and 504h may be provided to objects 505 and 506, respectively, at connection element sections 505b and 506b. Raised elements 502h and 504h are designed for support only, allowing connection element sections 505b and 506b respectively to move with as little friction as possible. Raised elements 502h and 504h may be provided rollers to reduce the contact friction on connection element sections 505b and 506b. Optional tension device 510 may be placed between connection element sections 505b and 506b to provide support for objects 505 and 506, to self-start torque system 500, and to provide additional torque benefits, as discussed above. Arms 501, 502, 503 and 504 are connected to axle 509 at axle section 509a. Objects 505 and 506 are designed to maximize the amount of centrifugal force converted to tangential force at connection locations A and B respectively. Object 505 is connected at connection location A along the radial direction of arm 501 by connection element section 505a. The direction of centrifugal force 513 acting on object 505 is tangential to connection element 505a, so that centrifugal force 513 creates maximum tangential force 511 at connection location A. Likewise, centrifugal force 514 acting on object 506 creates maximum tangential force 512 at connection location B.

Although shown as a single object connected at each of arms 501 and 502, torque system 500 may have multiple objects stacked on top each other connected to each of arms 501 and 502. For example, multiple raised elements similar to raised element 501f may be stacked on top of each other, each supporting an object similar to object 505. A similar configuration may be provided to support multiple objects at raised elements similar to raised element 503f. Optional support for the stacked objects may be provided by stacking raised elements that are similar to raised elements 502h and 504h. Multiple tension devices may also be stacked to increase both the starting torque and output torque.

In one embodiment, objects 505 and 506 of torque system 500 are modified to work with pulleys 505d and 506d, located respectively on arm 504 and 502. Rotation of torque system 500 is started by the gravity forces acting on objects 505 and 506. Objects 505 and 506 each have non-rigid connection elements 505e and 506e, each being made of cable, rope, cord, or any type of similarly constructed line. Connection elements 505e and 506e are flexible and have tensile strength, so as to transmit the forces between its ends. Connection element section 505e connects mass element 505f to connection element section 505b through pulley 505d. Connection element section 506e connects mass element 506f to connection element section 506b through pulley 506d. Pulleys 505d and 506d change the directions of the gravitational forces acting on mass elements 505f and 506f to the directions indicated by reference numerals 513 and 514, respectively, to induce forces in the directions 511 and 512 on arms 501 and 503, thus resulting in providing torques to rotate system 500. Once system 500 starts to rotate, mass elements 505f and 506f rotates and, in turn, create centrifugal forces to provide the output torque.

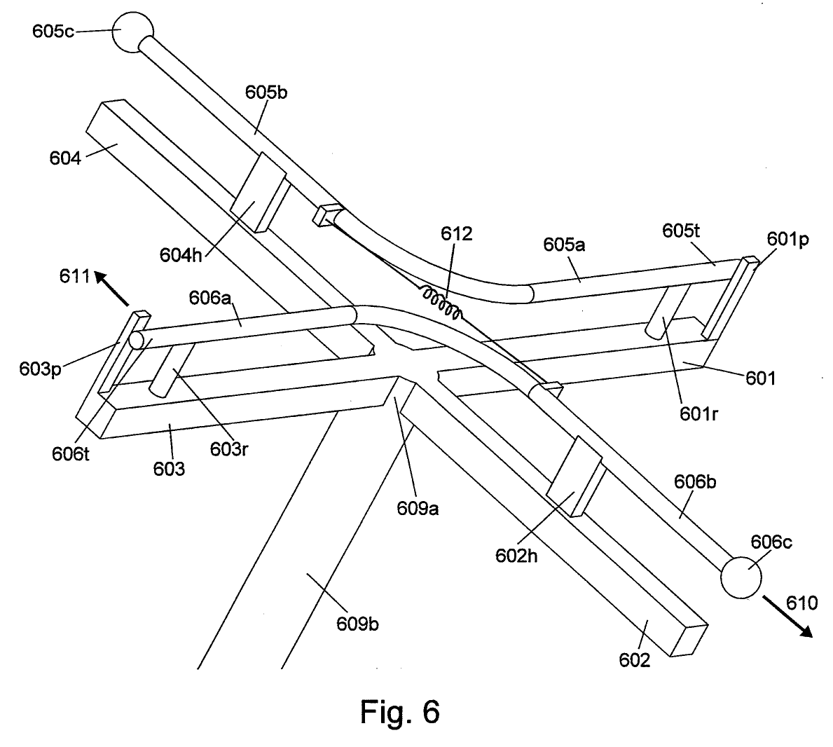

Objects shown in FIGS. 1-5 are kept stationary relative to the arms by being connected fixedly to the respective connection locations. Objects, however, may also be movable relative to their respective connection locations. FIG. 6 shows torque system 600 in which objects 605 and 606 are connected to arms 601 and 603, respectively, by rotatable elements 601r and 603r. Objects 605 and 606 can therefore also rotate about rotatable elements 601r and 603r, respectively. Raised elements 601p and 603p extend from arms 601 and 603 to reach heights above objects 605 and 606 to provide tangential forces to arms 601 and 603. Optional supports are provided for objects 605 and 606 by raised elements 602h and 604h, respectively, at connection element sections 605b and 606b. An optional tension device may be placed between connection element sections 605b and 606b to provide support for objects 605 and 606, to self-start torque system 600, and to provide extra torque benefits as discussed above. Arms 601, 602, 603 and 604 are connected to axle 609 at axle section 609a.

Object 605's connection element sections 605a and 605t form two-sided lever arm pivoted at rotatable element 601r. As torque system 600 rotates, centrifugal force 610 creates a tangential force at connection element section 605a, which causes object 605 to rotate about rotatable element 601r until connection element section 605t comes into contact with raised element 601p, thereby creating a tangential force on arm 601. The magnitude of tangential force on arm 601 due to centrifugal force 610 depends on the ratio of the distance between mass element 605c and rotatable element 601r to the distance between rotatable element 601r and raised element 601p. The closer rotatable element 601r is to raised element 601p, the larger is the tangential force on arm 601.

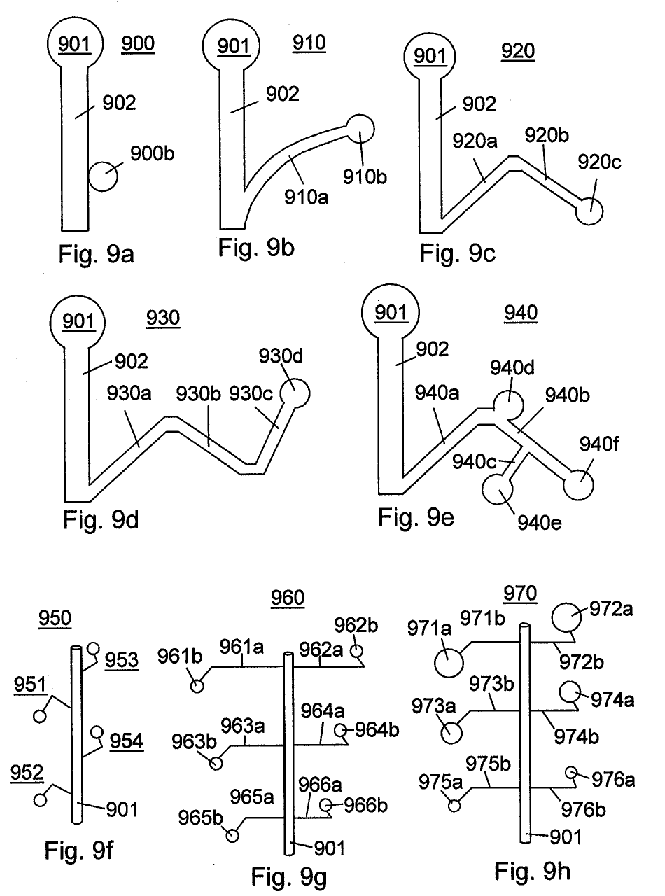

Inside an object, a connection element may include multiple connection element sections; likewise, a mass element may include multiple masses. FIGS. 9a-9e show examples of different variations of objects that can each be connected to arm 902 at one end to form torque systems 900, 910, 920, 930, and 940. (Arm 902 is coupled to axle 901 at the other end). FIGS. 9f-9h show examples of different variations of objects that can each be connected to axle 901 to form torque systems 950, 960, and 970. Axle 901 may be powered by external power to provide the rotation motion for the torque system. FIG. 9a shows torque system 900 with mass element 900b of object 900 connected to arm 902 without a connection element. Arm 902 may be considered an connection element for object 900. Connection elements may be integrated as part of an arm or as part of a mass element, where the mass element is shaped to unevenly distribute it mass. FIG. 9b shows torque system 910 that includes an object having curved connection element 910a and mass element 910b. FIG. 9c shows torque system 920 having an object consisting of mass element 920c and two straight connection element sections 920a and 920b. FIG. 9d shows torque system 930 having an object consisting of mass element 930d and three straight connection element sections 930a, 930b and 930c. FIG. 9e shows torque system 940 having an object consisting of multiple masses (940d, 940e and 940f) and multiple connection element sections (940a, 940b and 940c).

FIG. 9f shows torque system 950 having objects 951, 952, 953 and 954 that are connected directly along axle 901 and positioned circularly or spirally about the axle, to output torque axially, without force transmission mediated by arms. The total torque created by torque system 950 is sum of the torques created at all connection locations. Objects may be connected along axle 901 at any location in any configuration including spirally. FIG. 9g shows torque system 960 having objects 961, 962, 963, 964, 965 and 966 connecting directly to axle 901 axially to output torque. The mass elements of objects 961, 962, 963, 964, 965 and 966 are equal. The length of connection elements 961a and 962a are equal. The length of connection elements 963a and 964a are equal. The length of connection elements 961a is longer than the length of 963a, and the length of 963a is longer than the length of 965a.

Once torque system 960 is set into rotational motion initially by a rotational motion of axle 901, a centrifugal force is created on each object, which is directed at the axle, based on the direction of the centrifugal force and the connection angle of the connection element to the axle. When the centrifugal forces on objects 961, 962, 963, 964, 965 and 966 are all directed to a common axis, each acting at substantially the same connection angle with the connection element to the axle, objects 961 and 962 provide the largest torque to torque system 960 and objects 965 and 966 provide the smallest torque to torque system 960. Objects 961 and 962 may swap positions with objects 965 and 966, respectively, to have a larger torque created on the lower end of the axle. The lengths of the connection elements in torque system 960 may be arranged in a different order to achieve different results.

FIG. 9h shows that torque system 970 includes objects 971, 972, 973, 974, 975 and 976 all having connection elements with the same length attached to the axle 901 at the same angle. Mass elements 971a and 972a are provided the same mass, mass elements 973a and 974a are provided the same mass, and mass elements 975a and mass element 976a are provided the same mass. Mass elements 971a and 972a each have a larger mass than either of mass elements 973a and 974a, which each in turn have a larger mass than that of either mass elements 975a and 976a. When axle 901 rotates, top objects 971 and 972 create a larger torque than objects 973 and 974, which in turn create more torque than bottom objects 975 and 976 due to their differences in mass. Objects 971 and 972 may be swapped with objects 975 and 976. Torque systems 900, 910, 920, 930, 940, 950, 960 and 970 may each be partially or completely enclosed in a suitable housing. Objects 900, 910, 920, 930, 940, 950, 960 and 970 may be configured to form force systems, according to an embodiment of the present invention

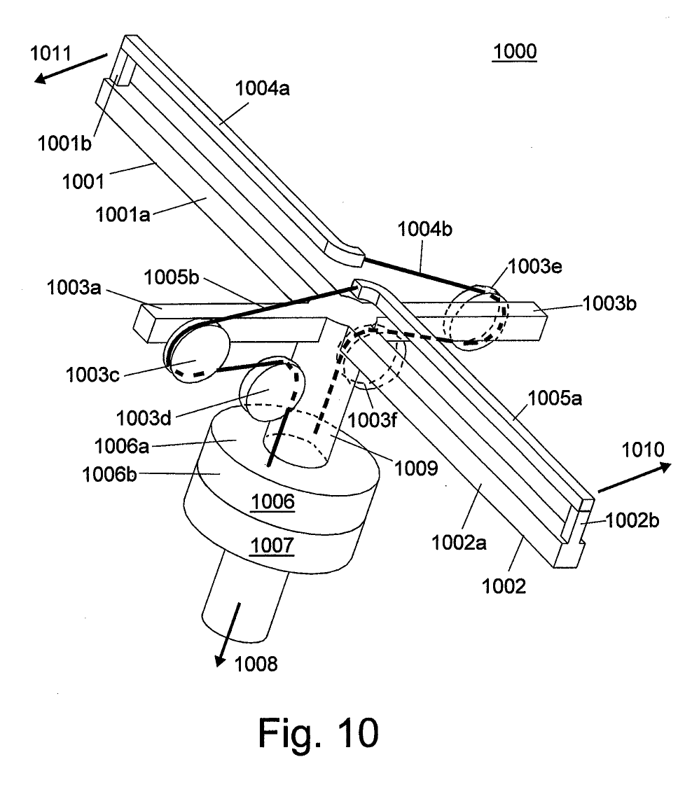

According to another embodiment of the present invention, FIG. 10 shows torque system 1000 having arms 1001 and 1002 attached to axle 1009 providing output torque. Pulleys 1003c, 1003d, 1003e and 1003f are coupling to axle 1009 through support arms 1003a and 1003b. Objects 1004 and 1005 are connected to rotatable structure 1006 to couple to force structure 1007. Force structure 1007 provides axial force 1008. Object 1004 has rigid connection element section 1004a connected to arm structure 1001b and non-rigid connection element section 1004b running through pulleys 1003e and 1003f to rotatable structure 1006. Object 1005 has rigid connection element section 1005a connected to arm structure 1002b and non-rigid connection element section 1005b running through pulleys 1003c and 1003d to rotatable structure 1006. Pulleys 1003c and 1003d are used to redirect force from force structure 1007 through rotatable structure 1006 to rigid connection element section 1005a to create a force 1010 at 1002b. Pulleys 1003e and 1003f redirect a force from force structure 1007 to rigid connection element section 1004a to create force 1011 at connection location 1001b. Rotatable structure 1006 rotates with axle 1009 and non-rigid connection element section 1004b and 1005b. Force structure 1007 may rotate with rotatable structure 1006 (or may be stationary) by being connected to rotatable structure 1006 through bearings (not shown).

Torque system 1000 uses force structure 1007 to provide an axial force 1008 using gravitational forces, hydraulics or any other method to create a unidirectional force. Force 1008 creates torques on arms 1001 and 1002 through objects 1004 and 1005. The torque created on arms 1001 and 1002 is sustained as long as there is a force created by force structure 1007. Torque system 1000 uses a unidirectional force to create rotational motion for the system. When force structure 1007 rotates with rotatable structure 1006, force structure 1007 may act as a flywheel for storing rotational energy. When force structure 1007 is stationary, the complexity of integrating mechanical methods for creating force 1008 to drive torque system 1000 is reduced.

A centrifugal system such as a torque system of the present invention may have different objects with different mass elements to drive an axle output based on the centrifugal force acting upon the arms in the torque system. A torque system is typically driven to a specific rotational velocity before torque is output. As the objects continue to rotate, the torque generated by the objects causes the angular velocity of the system to increase, including the objects' angular velocities. When the system reaches a specific angular velocity, rotation of the objects may be stopped, as the objects have produced a sufficient amount of output torque or a sufficiently large system angular velocity to maintain the motion of the system.

In the centrifugal systems, objects having different lengths in their connection elements may be positioned circularly or spirally about the output axle. As shown in FIGS. 1-6 and 9 above, the connection elements of the objects are provided, for illustrative purpose, as rigid connection elements to create torque. As shown in FIG. 10 above, the connection elements of the objects are provided, for illustrative purpose, as rigid connection elements to create torque output and as non-rigid connection elements to create force output.

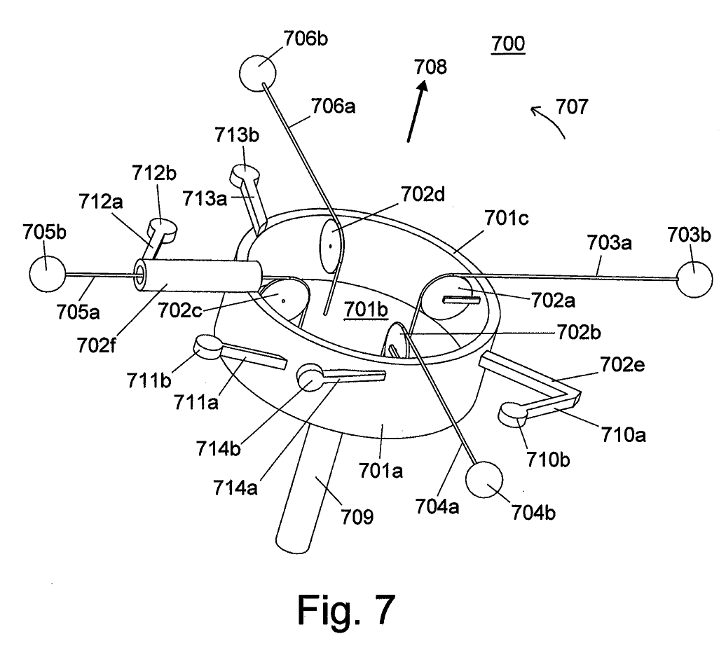

FIG. 7 shows an open centrifugal system 700, according to one embodiment of the present invention, using the principles discussed above. As shown in FIG. 7, force system 700 includes container 701, having peripheral portion 701a and bottom portion 701b, which connects to axle 709 that allows external power to start thrust system 700 by rotating axle 709. Pulleys 702a, 702b, 702c and 702d are each structurally attached to an interior wall of peripheral portion 70 la to change the direction of a radial centrifugal force to a predetermined direction (“unidirectional”) force. Object 703, 704, 705 and 706 include, respectively, connection elements 703a, 704a, 705a and 706a, and mass elements 703b, 704b, 705b and 706b. The connection elements in objects 703, 704, 705 and 706 may consist of cable, rope, cord, line, wire, string, chain, or any type of similarly constructed line which is flexible and with tensile strength, so as to transmit the forces between its ends. Each of connection elements 703a, 704a, 705a and 706a has one end connected to the interior of container 701 at bottom portion 701 b. Force system 700 is set into rotational motion in direction 707 by an external power source which drives axle 709. During operation, the centrifugal forces due to the rotational motions of mass elements 703b, 704b, 705b and 706b are transmitted by connection elements 703a, 704a, 705a and 706a to bottom portion 701b of container 701 through stationary pulleys 702a, 702b, 702c and 702d, thereby creating axial force 708. Therefore, force system 700 converts centrifugal forces of rotating objects into a unidirectional force which can be used to move force system 700, the drive system driving force system 700 and all components coupled to the drive system. Pulleys 702a, 702 b, 702c and 702d may be structurally adapted to attach to rim portion 701c of housing 701. More pulleys or other suitable structures may be used to enhance the structural integrity of the system.

Within force system 700 is provided a number of optimum configured objects that are oriented to create a thrust using the rotational motion of the objects. This thrust may be used to drive force system 700, which is attached to axle 709, in a predetermined direction. The amount of force output from force system 700 depends on the mass elements, their angular velocities and the distance between each mass element and the axis of rotation. The lengths of connection elements 703a, 703b, 703c and 703d may be dynamically changed during operation to control the amount of thrust force created. Connection element of objects may be adjusted to control the thrust as well as the rotational velocity of axle. The length of a connection element may also have portions that are made up of one or more springs. In one embodiment, force system 700 has cable elements that are adjustable in length, or have portions with one or more springs. The output thrust force of force system 700 may be controlled by a control unit (not shown). Force system 700 may be configured as an enclosed system depending on the requirements.

FIG. 7 also shows objects with rigid connection elements similar to objects in torque system 100, 200, 300 and 400 of FIGS. 1-4 above, and which may be placed in locations of force system 700 at suitable angles to provide torque to help configuration system 700 to rotate. For example, as shown in FIG. 7, arm 702e is connected to an exterior wall of peripheral portion 701a at one end and extends radially outward, connecting to object 710 formed by connection element 710a and mass element 710b. Similarly, support 702f, which is connected to rim portion 701c, extends radially outward and has connection element 705a running inside, so that the motion of connection element 705a is not be restricted. Support 702f may be used as an arm with object 712 attached. As shown in FIG. 7, (a) object 711 is connected directly to and away from peripheral portion 701a, (b) object 714 is connected directly to and along peripheral portion 701a, and (c) object 713 is directly connected to rim portion 701c and positioned outward. Objects 710, 711, 712, 713 and 714 all contribute to create torque for force system 700. Objects that are similar to objects 505, 506 of torque system 500, and objects 605, 606 of torque system 600, may be placed on rim portion 701c with some extra configurations to provide torque for axle 709 to rotate. Force system 700 may be partially, or completely, enclosed in housing.

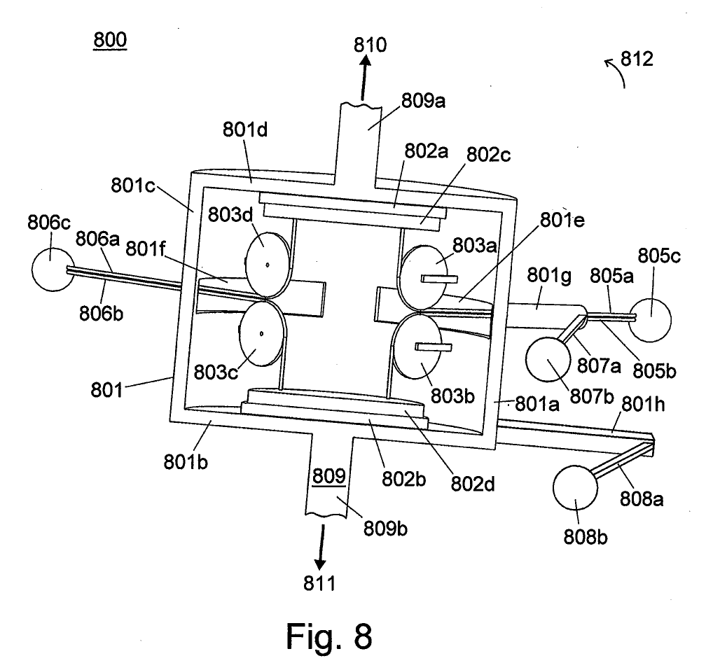

FIG. 8 shows force system 800 providing a control mechanism for creating the bidirectional force, in accordance with one embodiment of the present invention. Force system 800 has housing 801 that is structurally connected to axle 809, which allows external power to rotate force system 800. Force system 800 includes object 805 and object 806. Housing 801 includes housing portions 801a, 801b, 801c and 801d. Inside housing 801, control units 802a and 802b that are attached to housing portions 801d and 801b, respectively, are provided to control tension units 802c and 802d. Tension units 802c and 802d are each designed to move axially to control tensions between connection elements 805a, 805b, 806a and 806b and their respective mass elements 805c and 806c of objects 805 and 806. The forces due to objects 805 and 806 created on tension units 802c and 802d are each proportional to the respective tension forces on connection elements 805a, 805b, 806a and 806b attached to the tension units. During operation, control units 802a and 802b control the axial positions of tension units 802c and 802d to dynamically change the forces created on tension units 802c and 802d respectively. The forces due to the connection elements attached to tension unit 802a creates a thrust force in direction 811 and, likewise, the forces due to connection elements attached to tension unit 802b creates a thrust force in direction 810.

As shown in FIG. 8, object 805 has connection elements 805a and 805b both attached to mass element 805c, which is positioned to create a thrust on axle 809 from the rotational motion of the system in the direction indicated by reference numeral 812. Connection element 805a runs through housing opening 801e to pulley 803a inside housing, so as to attach to tension unit 802c. Similarly, connection element 805b attaches to tension unit 802d through housing opening 801e and pulley 803b inside housing 801. Object 806 has connection elements 806a and 806b both attached to mass element 806c. Connection element 806a runs through housing opening 801f to pulley 803d inside housing to attach to tension unit 802c. Connection element 806b attaches to tension unit 802d through housing opening 801f and pulley 803c inside housing 801. Connection elements 805a, 805b, 806a and 806b may be cables, ropes or another type of flexible material capable of handling forces between mass elements 805c and 806c and tension units 802c and 802d. Before operation, when tension units 802c and 802d are in their axial position closest to control units 802a and 802b respectively, the lengths of connection elements 805a and 805b are equal. Similarly, the lengths of connection elements 806a and 806b are equal. Tension unit 802c controls the lengths of connection elements 805a and 806a and tension unit 802d controls the lengths of connection elements 805b and 806b. During operation, the larger magnitude among the tensions provided in the connection elements of an object determine which associated tension unit outputs the thrust force (and the direction of the resulting thrust). For example, if connection element 805a has a larger magnitude in tension than connection element 805b, tension unit 802c will output a thrust force in direction 811. Conversely, if connection element 806a has a smaller magnitude in the tension force than connection element 806b, tension unit 802d outputs a thrust force in direction 810.

Object 805 and 806 are arranged radially to provide the centrifugal forces due to the rotation of force system 800. Pulleys 803a, 803b, 803c and 803d are structurally adapted to interior walls of housing portions 801a and 801c and positioned to allow transforming the centrifugal forces on connection elements 805a, 805b, 806a and 806b to contribute to a unidirectional force on axle 809. Force system 800 is initially set into rotational motion in the direction indicated by 812, with tension units 802c and 802d in axial positions such that the lengths of connection elements 805a and 805b are equal and the lengths of connection elements 806a and 806b are equal, thus creating a zero net thrust force. To create a thrust force in direction 810, control unit 802a moves tension unit 802c away from control unit 802a, such that the lengths of connection elements 805a and 806a are longer than the corresponding lengths of connection elements 805b and 806b, respectively. When tension unit 802c is moving closer to control unit 802a, the lengths of connection elements 805a and 806a are shorter than corresponding lengths of connection elements 805b and 806b, respectively. When tension unit 802d is moving closer to control unit 802b, the lengths of connection elements 805a and 806a are longer than the lengths of connection elements 805b and 806b, respectively. To create a thrust force in direction 811, control unit 802b moves tension unit 802d away from control unit 802b, such that the lengths of connection elements 805b and 806b are longer than the lengths of connection elements 805a and 806a respectively. The thrust force increases when the rotational velocity of force system 800 increases, or when the distance between a tension unit producing a thrust and its associated control unit changes. Optionally, connection elements 805a, 805b, 806a and 806b may be adjusted to control the thrust as well as the rotational velocity of axle or have extra lengths stored within tension units 802c and 802d for control units 802a and 802b, so as to control thrust output. Force system 800 allows the control of a thrust force in a forward, reverse or stop position without stopping the axle rotation.

Objects with rigid connection elements similar to the objects in torque system 100, 200, 300 and 400 may be placed in any location of force system 800 at suitable angles, so as to provide a torque to help the system to rotate. For example, in FIG. 8, arm 801h is connected to an exterior wall of housing portion 801a and extends radially outward. Object 808, which is attached to arm 801h, includes connection element 808a and mass element 808b. Support 801g, which is connected to housing portion 801a, extends radially outward with connection elements 805a and 805b running inside, such that the motions of connection elements 805a and 805b are not restricted. Support 801g may be used as an arm with object 807 attached. Objects may be connected directly or indirectly to suitable position and angle to contribute to torque creation in force system 800. Similar objects to objects 505, 506, 605 and 606 of torque systems 500 and 600 may be placed on housing portion 80 1b, 801d, or inside housing 801, with some configurations, to provide torque for rotating axle 809. Force system 800 may be partially or completely enclosed in a housing.

A centrifugal system such as a force system of the present invention may have different objects with different mass elements for driving an axle output based on the centrifugal force acting upon the system. A force system is typically driven to a specific rotational velocity before force is output. As the objects continue to rotate, the centrifugal forces generated by the objects are used to output the directional force. Housings 701 or 801 may be configured as a rod, a shaft or an arm, or be integrated into the axle or another support structures. Pulleys (e.g. 702a or 803a) may be replaced by a track or other structure that provides a similar function of changes the direction of a force.

In the centrifugal systems of the present invention, objects having different lengths in their connection elements may be positioned circularly or spirally about the output axle. As shown in FIGS. 7-8 above, the connection elements of the objects are provided, for illustrative purpose, as non-rigid connection elements to create force output. Arms or connection elements or any suitable structures of the centrifugal systems may be designed to have air-foil shape sections, so as to provide lift forces to move fluid in applications such as fans, pumps, impellers, compressors, or blowers, depending on the configuration of arms, connection elements and the applications of the centrifugal system. According to the present invention, the centrifugal system may include one or more mechanisms that allow the objects or arms to be retracted from the rotational motion, when mechanical output power or force is not needed to drive the axle or the system, so as to reduce losses due to friction.

In one embodiment of the centrifugal system, the angle between the connection element and the torque arm of a torque system or the angle between the connection element and the axle of a force system, the total mass of the mass elements, and the distance between mass elements and the axis of the rotation may be adjusted. Each type of adjustment may be provided over a range that is sufficient to maximize the contribution of the adjustment to the centrifugal forces induced by the mass elements. Connection elements may be tilted or curved, and be adjusted relative to the centrifugal direction, in response to object velocity and to torque system or force system motion, so as to maximize system output. A torque control mechanism that controls the adjustable portions of arms and objects during operation may be used to alter the angular velocity for rotational objects or the centrifugal system.

The objects creating torque or force for the centrifugal system may be located anywhere where torque or force creation can be achieved. The objects shown in FIGS. 1-10 above are positioned merely to illustrate the present invention and are not intended to be limiting. Each object's geometry and placement position depend on many system design parameters, including the distance to axis of rotation, system weight, the number of arms, motion, rotational velocity and angle of attack, optimized to create the greatest amount of torque output. After an object creates centrifugal force on an arm, torque systems output may increase the rotational velocity of axle. The centrifugal system's torque or force output may be maximized by altering the total mass of mass element, angle of the centrifugal force applied on structures of the system and the distance from the application of the centrifugal forces to the axis of rotation. The rotary motion of the rotary centrifugal systems may be used to create torque or directional force.

As discussed above, a centrifugal system including a torque system or a force system may be an enclosed or an unenclosed system. In an enclosed centrifugal system, a portion or all of the system may operate in vacuum or in an optimized environment to reduce energy loss due to friction or resistance. Various considerations of system configuration, object locations, object configurations, the number of objects, the torque arm radius, object shapes, the masses of objects, angle between a connection element and an arm or axle, and the desired object velocities are all design parameters that can be tuned for high performance. The embodiments of the present invention may be implemented using MEMS or other technologies.

The number of centrifugal system mechanism assemblies in each system and their respective strengths are variable. With little design modifications, springs can be compressed or extended. The centrifugal system mechanism assemblies can be relocated and be modified to obtain the same or greater centrifugal system results. Selection of the materials for the objects and their respective strengths, though important design considerations, are within the conventional skills of those skill in the art.

The output of a centrifugal system depends on the rotational speeds of the objects in the system. The output of a centrifugal system depends on the rotational speeds of the objects in the system. According to one embodiment of the present invention, mass elements of the objects in a centrifugal system may be spherical or air-foil objects. For system efficiency, the mass elements are preferably aerodynamic objects having a lift-to-drag ratio of preferably greater than one. When the mass elements of the objects are positioned and oriented appropriately, the mass elements have combined centrifugal forces and lift forces induced by aerodynamic effects of the mass elements. These combined forces can be directed to increase torque generation or increase force generation for centrifugal systems. A control mechanism can be provided to slow or stop the system.

As discussed above, a centrifugal system may be partially enclosed, fully enclosed or completely unenclosed. A centrifugal system can provide torque or force output using the rotational motion due to centrifugal force vectors, lift forces and tension forces. (Tension forces are illustrated, for example, by the springs in torque system 400). By varying the number of objects and the manner of connection and orientation, variations in the desired torque or force output may be achieved. Numerous such torque systems or force systems may be connected in series or in parallel depending on the desired torque output required.

In a centrifugal system, the connection angle between an object's connection element and the arm or the axle may be any suitable angle that contributes a force on torque or force output. The mass of an object's mass elements should be large enough to contribute a centrifugal force. The mass of the connection element may also contribute to the mass creating the centrifugal force of an object. A connection element's strength is designed to hold its design integrity. Objects and arms may be located on different planes perpendicular to the axis of rotation. If an object is located on a different perpendicular plane to the axis of rotation than the arm, then the centrifugal force contributed by the object is based on the object's projected plane on the arm plane perpendicular to the axis of rotation. Objects may have connection elements that are spiral or circular shaped so that the objects have both height and width dimensions. Tension devices such as springs may also provide system integrity to a centrifugal system. A tension device may be a compressed spring, hydraulic or any similar mechanism that can create a force against a mass element. The location of a tension device and direction of the force from a tension device being applied on a mass element may be anywhere that provides a torque on the centrifugal system.

The present invention is applicable to systems that have unbalanced weight or angular momentum which may be used to increase torque or force for certain systems such as systems that combine gravity or other physical effects with centrifugal forces from centrifugal systems. An arm may be adjustable during operation including adjusting the connection angle to the axle, the length or the shape (i.e. having one or more sections that can move). Arms may be straight or curved and may extend from the axle at any angle depending on the application. Mass elements can be spherical, annular, cylindrical or any shape and may provide extra benefits depending on the application including reduced friction and increase force due to aerodynamic effects. A mass element may have multiple structures each with the same or different mass sharing a center of mass represented by a single structure.

While the centrifugal systems shown in FIGS. 1-10 each have an even number objects, centrifugal systems may also have an odd number of objects. The objects preferably should be positioned such that the centrifugal forces due to the objects are balanced around the centrifugal system's axis of rotation. Configurations of objects and other system parameters for torque systems and force systems may be similar. This application is related to a system using centrifugal force created from rotational motion of one or more objects coupled to an axle to create torque or force on a drive shaft or on the system. According to the present invention, a torque or force may be output by any suitable structures depending on the system configuration, for example, an axle. The principles of the invention are not necessarily limited to “power generation” in the traditional sense, but rather may extend to any system requiring propulsion or rotational energy, including nano-scale objects, parts of larger machines, and even objects that merely rotate.

The above detailed description is provided to illustrate specific embodiments of the present invention and is not intended to be limiting. Numerous variations and modifications within the scope of the present invention are possible. The present invention is set forth in the accompanying claims.

We claim:

1. A centrifugal system for converting centrifugal force to torque, comprising:
an energy output device;
an arm coupled to the energy output device; and
a first mass element coupled to the arm at a predetermined angle, wherein a rotational motion of the first mass element creates a torque in the arm.

2. A centrifugal system as in claim 1, wherein the energy output device comprises an axle.

3. A centrifugal system as in claim 1, further comprising a connection element is rigid.

4. A centrifugal system as in claim 3, wherein (a) the first mass element is one of a plurality of mass elements of the centrifugal system, (b) the arm is one of a plurality of arms of the centrifugal system, each arm being coupled to provide energy output to the output device, and (c) the connection element is one of a plurality of connection elements each coupled to and associated with one of the mass elements and one of the arms, each connection element being configured to create a torque in the associated arm as a result of a rotational motion of the associated mass element.

5. A centrifugal system as in claim 4, wherein the mass elements rotate about a common axis.

6. A centrifugal system as in claim 4, further comprises a spring element, such that a release of energy stored in the spring element initiates the rotational motion of the mass element.

7. A centrifugal system as in claim 1, wherein the mass element comprises a plurality of masses.

8. A centrifugal system as in claim 1, wherein the connection element comprises a plurality of connection members stacked along a predetermined direction.

9. A centrifugal system as in claim 1, further comprising a housing including a space that encloses the mass element and the connection element.

10. A centrifugal system as in claim 9, wherein the space is partially evacuated.

11. A centrifugal system as in claim 9, wherein the space is filled with a fluid.

12. A centrifugal system as in claim 1, wherein the connection element is supported on the arm by a raised element that allows the connection element to rotate relative to the arm.

13. A centrifugal system as in claim 12, wherein the ratio of the distance between the mass element and the raised element to the distance between the raised element and where the torque is created on the arm is a predetermined value.

14. A centrifugal system as in claim 1, wherein the connection element includes one or more bends.

15. A centrifugal system for converting centrifugal force to linear force, comprising:
a rotatable structure; and
a first mass element coupled to the rotatable structure, wherein a rotational motion of the first mass element creates a force in the rotatable structure.

16. A centrifugal system as in claim 15, further comprises a flexible connection element connecting the first mass element to the rotatable structure.

17. A centrifugal system as in claim 16, further comprises means for adjusting a length of the connection element

18. A centrifugal system as in claim 16, further comprises a pulley that changes the direction of a force in the connection element to a predetermined direction.

19. A centrifugal system as in claim 18, wherein (a) the first mass element is one of a plurality of mass elements of the centrifugal system, and (b) the flexible connection element is one of a plurality of flexible connection elements each being coupled to and associated with one of the mass elements, and further comprises a first set of pulleys that changes the direction of a force in each flexible connection element to a predetermined direction common to the connection elements.

20. A centrifugal system as in claim 19, further comprising a second group of connection elements each being coupled to and associated with one of the mass elements, and further comprises a second set of pulleys that changes the direction of a force in the flexible connection element to a second predetermined direction common to the connection elements of the second group.

21. A centrifugal system as in claim 20, wherein one of mass elements is coupled to both a first flexible connection element in the first group of connection elements and a second flexible connection elements of the second group, and wherein the relative lengths of the first and second connection elements affect the direction of motion of the centrifugal system.
